(19) United States
(12) Patent Application Publication
(10) Pub. No.: US 2026/0331407 A1
(43) Pub. Date: Oct. 22, 2026

(54) FUSE UNIT AND CONDUCTIVE MODULE

(71) Applicant: YAZAKI CORPORATION, Tokyo (JP)

(72) Inventors: Kota Morishige, Makinohara-shi (JP); Katsunori Sato, Makinohara-shi (JP); Yasuhiro Kominato, Makinohara-shi (JP); Mariko Nakagawa, Makinohara-shi (JP); Miho Suzuki, Makinohara-shi (JP)

(21) Appl. No.: 19/647,297

(22) Filed: Apr. 14, 2026

(30) Foreign Application Priority Data
Apr. 16, 2025 (JP) 2025-067304

(51) Int. Cl. H01H 85/055; H01H 85/143

(52) U.S. Cl. CPC H01H 85/055; H01H 85/143

(57) ABSTRACT

A fuse unit includes a chip fuse, a first terminal fitting including a first electrical connection portion electrically connected to a first electrode of the chip fuse and electrically connected to a connection conductor (first electrical connection target), and a second terminal fitting including a second electrical connection portion electrically connected to a second electrode of the chip fuse and electrically connected to a battery monitoring unit (second electrical connection target), wherein the first electrical connection portion and the second electrical connection portion are provided with a pair of recesses recessed from respective distal end surfaces in directions away from each other in an arrangement direction of the first terminal fitting and the second terminal fitting, into which the chip fuse is fitted.

### CROSS-REFERENCE TO RELATED APPLICATIONS

The present application claims priority to and incorporates by reference the entire contents of Japanese Patent Application No. 2025-067304 filed in Japan on April 16, 2025.

### BACKGROUND OF THE INVENTION

### 1. Field of the Invention

The present invention relates to a fuse unit and a conductive module.

### 2. Description of the Related Art

A conductive module, in a battery module in which a plurality of battery cells are arranged, electrically connects the plurality of battery cells using a plurality of connection conductors. Then, the conductive module electrically connects each connection conductor to a battery monitoring unit that monitors the battery states of the battery cells using a wiring material such as an electric wire. For example, Japanese Patent Application Laid-open No. JP 2020 - 119 651 A below discloses this type of conductive module. In such a conductive module, a combination of a pair of a connection conductor and a conductor portion of a wiring material may be provided for each connection conductor, and a circuit protection component such as a fuse may be interposed between the connection conductor and the conductor portion of the wiring material in each combination. For example, Japanese Patent No. JP 7 561 318 B1 below discloses a fuse unit (composed of a chip fuse, a pair of terminal fittings, and a resin member) applied to the conductive module.

However, in the conventional fuse unit described above, for example, there is room for further improvement in workability of assembling work of a chip fuse, a pair of terminal fittings, and the like, which are components of the fuse unit.

### SUMMARY OF THE INVENTION

The present invention has been made in view of the above circumstances, and an object of the present invention is to provide a fuse unit and a conductive module capable of improving workability of assembling work.

In order to achieve the above mentioned object, a fuse unit according to one aspect of the present invention includes a chip fuse that melts a fusible portion when an overcurrent flows between a first electrical connection target and a second electrical connection target; a first terminal fitting including a first electrical connection portion electrically connected to a first electrode of the chip fuse, and electrically connected to the first electrical connection target; and a second terminal fitting including a second electrical connection portion electrically connected to a second electrode of the chip fuse, and electrically connected to the second electrical connection target, wherein the first electrical connection portion and the second electrical connection portion are provided with a pair of recesses recessed from respective distal end surfaces in directions away from each other in an arrangement direction of the first terminal fitting and the second terminal fitting, into which the chip fuse is fitted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a conductive module to which a fuse unit according to an embodiment is applied;

FIG. 2 is an exemplary perspective view of a battery module and a connection conductor according to the embodiment;

FIG. 3 is an exemplary perspective view of a fuse unit according to the embodiment;

FIG. 4 is an exemplary exploded perspective view of the fuse unit according to the embodiment;

FIG. 5 is an exemplary exploded perspective view of the fuse unit according to the embodiment as viewed from an angle different from that in FIG. 4;

FIG. 6 is an exemplary perspective view of the vicinity of a recess of a fuse unit according to a first modified example;

FIG. 7 is an exemplary perspective view of a chip fuse of the fuse unit according to the first modified example;

FIG. 8 is an exemplary side view of a fuse unit according to a second modified example; and

FIG. 9 is an exemplary side view of a fuse unit according to a third modified example.

### DETAILED DESCRIPTION OF THE PREFERRED EMBODIMENTS

Hereinafter, embodiments and modified examples according to the present invention will be described in detail with reference to the drawings. Note that the present invention is not limited by the following embodiments and modified examples. In addition, constituent elements in the following embodiments and modified examples include those that can be easily replaced by those skilled in the art, or those that are substantially the same.

In addition, the embodiments and modified examples disclosed below include similar components. Therefore, in the following description, common reference numerals are given to these similar components, and redundant description is omitted. In the present specification, ordinal numbers are used only to distinguish components, members, parts, positions, directions, and the like, and do not indicate order or priority.

### Embodiments

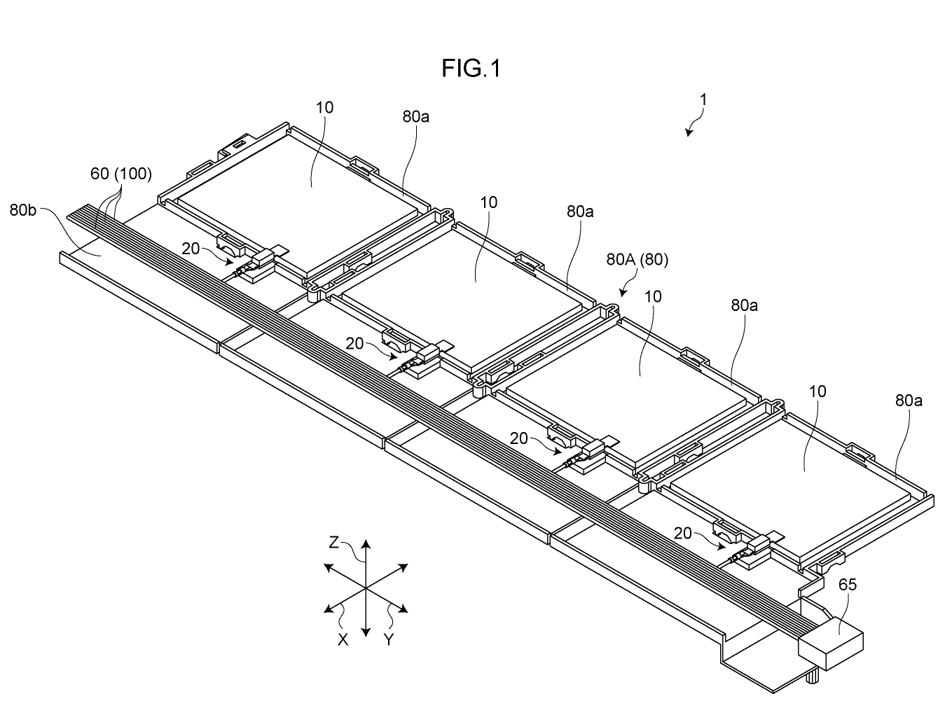

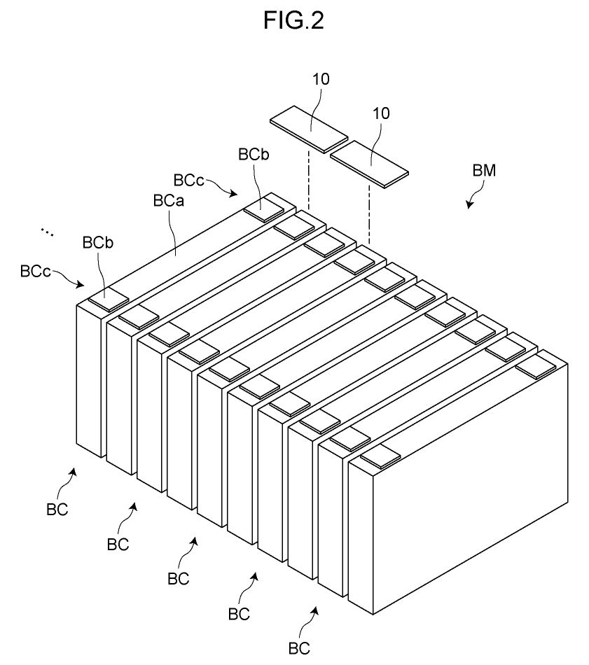

FIG. 1 is an exemplary perspective view of a conductive module 1 to which a fuse unit 20 according to an embodiment is applied. The conductive module 1 of the present embodiment illustrated in FIG. 1 is, for example, assembled to a battery module BM in which a plurality of battery cells BC (refer to FIG. 2) are arranged, and is electrically connected to the plurality of battery cells BC in the battery module BM. In addition, the conductive module 1 causes a battery monitoring unit 100 to monitor the battery states of the battery cells BC by electrically connecting the battery module BM to the battery monitoring unit 100. The conductive module 1 constitutes a battery pack together with the battery module BM. The battery pack is mounted on, for example, a vehicle (BEV: Battery Electric Vehicle, HEV: Hybrid Electric Vehicle, etc.) including a rotary machine as a drive source, and is used for power supply to the rotary machine. In FIG. 1, for convenience, the unit body of the battery monitoring unit 100 is not illustrated, and only a wiring member 60 of the battery monitoring unit 100 is illustrated.

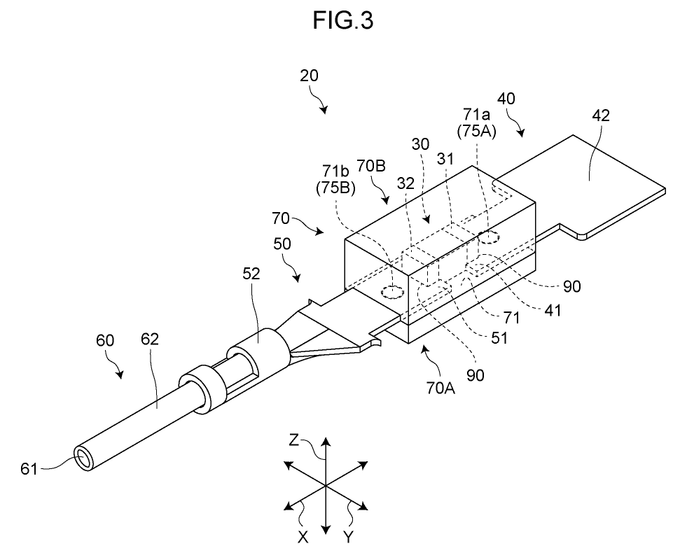

In the following description, among a first direction, a second direction, and a third direction intersecting each other, the first direction is referred to as an "arrangement direction X," the second direction is referred to as a "width direction Y," and the third direction is referred to as a "height direction Z". Here, the arrangement direction X, the width direction Y, and the height direction Z are substantially orthogonal to each other. Typically, the arrangement direction X corresponds to a lateral direction of the conductive module 1, a longitudinal direction of a fuse unit 20, a direction in which a first terminal fitting 40 (refer to FIG. 3) and a second terminal fitting 50 of the fuse unit 20, which will be described later, are arranged, or the like. Typically, the width direction Y corresponds to a longitudinal direction of the conductive module 1, a width direction of the fuse unit 20, or the like. Typically, the height direction Z corresponds to a height direction (vertical direction) or the like of the conductive module 1 and the fuse unit 20. Each direction used in the following description will be described as a direction in a state where the fuse unit 20 is assembled to the conductive module 1 unless otherwise specified.

FIG. 2 is a perspective view of the battery module BM and a connection conductor 10. The battery cell BC includes, for example, a cell body BCa and positive and negative electrode terminals BCb. In the battery module BM, a plurality of battery cells BC are arranged in a row in an array direction (width direction Y). The battery module BM includes one electrode terminal group BCc in which one electrode terminal BCb of the plurality of battery cells BC is arranged in the array direction, and the other electrode terminal group BCc in which the other electrode terminal BCb of the plurality of battery cells BC is arranged in the array direction.

The battery cell BC is formed in, for example, a rectangular parallelepiped shape in which the cell body BCa has six outer wall surfaces. In the plurality of battery cells BC, cell bodies BCa adjacent to each other in the array direction are disposed with one outer wall surface facing each other. For example, in the battery cell BC, the positive and negative electrode terminals BCb are disposed on one of the six outer wall surfaces of the cell body BCa or separately arranged on two of the six outer wall surfaces of the cell body BCa. In this example, each battery cell BC includes the positive and negative electrode terminals BCb on one of the six outer wall surfaces of the cell body BCa. Therefore, in the battery module BM, two electrode terminal groups BCc are provided on one plane.

The electrode terminal BCb is formed in, for example, a flat plate shape, and directly electrically connects the connection conductor 10 which will be described later by laser welding or the like. However, the electrode terminal BCb may be formed in a pole shape having a male screw portion. In this case, the connection conductor 10 is screwed and fixed to the electrode terminal BCb by screwing a female screw member to the male screw portion of the electrode terminal BCb.

The conductive module 1 includes, for example, the connection conductor 10 directly electrically connected to the electrode terminals BCb of the battery cells BC constituting the battery module BM. The connection conductor 10 is formed of a conductive material such as metal. The connection conductor 10 is a metal plate-like conductive component called a bus bar, and is press-molded using a metal plate as a base material, for example. The connection conductor 10 illustrated here is formed in a rectangular flat plate shape.

The conductive module 1 includes, as the connection conductor 10, for example, one directly electrically connected to the adjacent electrode terminals BCb of a pair of battery cells BC in the battery module BM, one directly electrically connected to the electrode terminal BCb serving as a common negative electrode in the battery module BM, and one directly electrically connected to the electrode terminal BCb serving as a common positive electrode in the battery module BM.

Further, the conductive module 1 includes the connection conductor 10 and the fuse unit 20. The fuse unit 20 is connected between the connection conductor 10 and the battery monitoring unit 100. For example, the fuse unit 20 indirectly electrically connects the connection conductor 10 and the battery monitoring unit 100, and cuts off current flow when an overcurrent flows therebetween. The fuse unit 20 is provided for each connection conductor 10 (refer to FIG. 1).

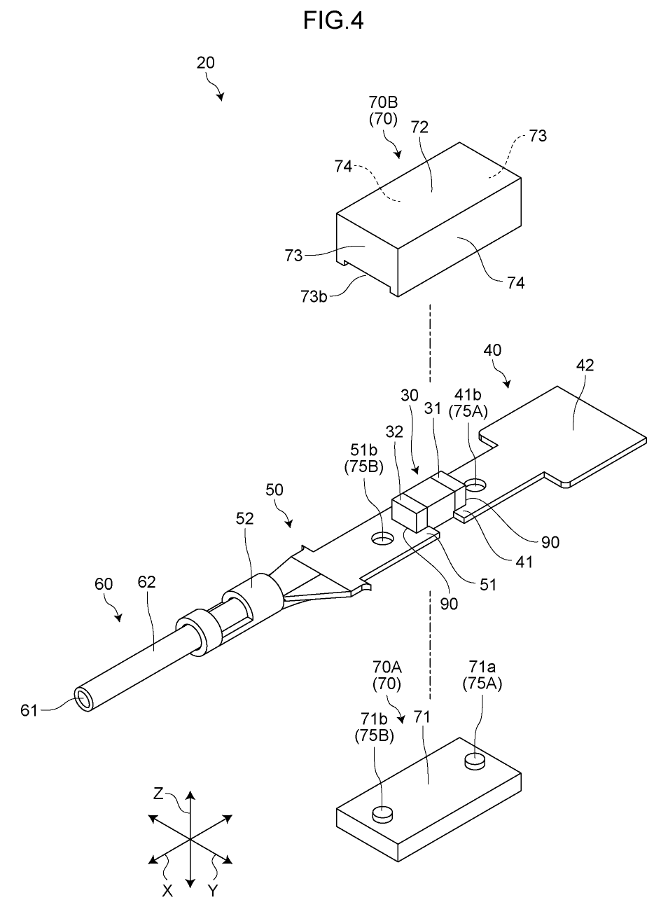

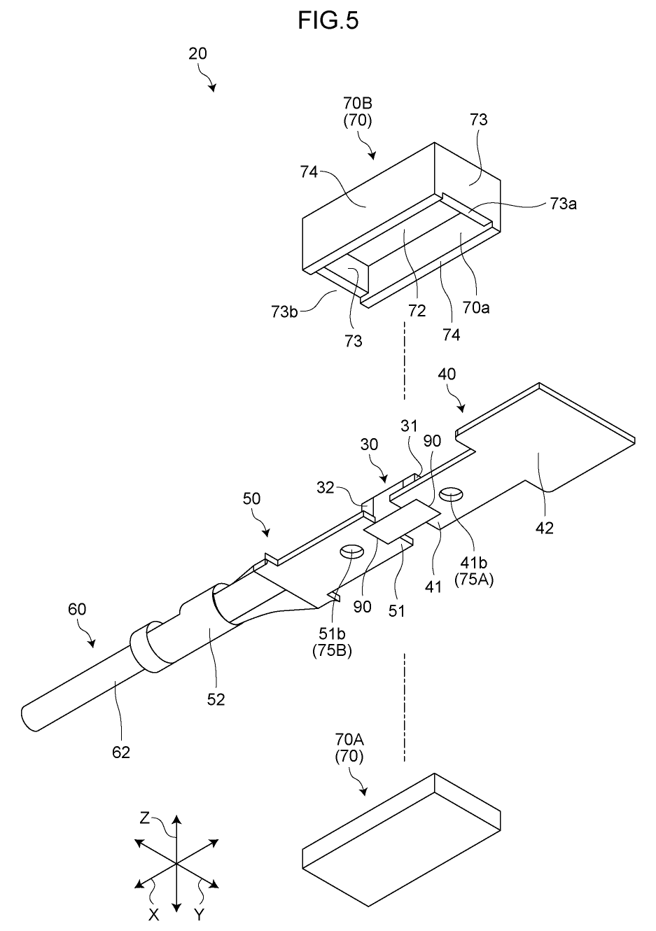

FIG. 3 is a perspective view of the fuse unit 20, FIG. 4 is an exploded perspective view of the fuse unit 20, and FIG. 5 is an exploded perspective view of the fuse unit 20 as viewed from an angle different from that in FIG. 4. As illustrated in FIGS. 3 - 5, the fuse unit 20 includes, for example, a chip fuse 30, a first terminal fitting 40, a second terminal fitting 50, and a resin member 70. The chip fuse 30 is a circuit protection component that melts a fusible portion when an overcurrent flows between the connection conductor 10 and the battery monitoring unit 100 described above. The chip fuse 30 includes, for example, a first electrode 31, a second electrode 32, and a fusible portion disposed between the first electrode 31 and the second electrode 32. The first electrode 31 and the second electrode 32 are disposed on a straight line by being divided into one end portion and the other end portion in the arrangement direction X of the chip fuse 30.

The chip fuse 30 is, for example, configured as a surface-mountable chip component having a fusible portion, configured as a pattern fuse in which a wiring pattern having a fusible portion is provided on a printed circuit board (for example, a flexible printed circuit board), or the like. The chip fuse 30 illustrated here is configured as a rectangular parallelepiped chip component. The first electrode 31 is provided at one end portion in the alignment direction X of the chip fuse 30, and the second electrode 32 is provided at the other end portion in the alignment direction X of the chip fuse 30.

The first terminal fitting 40 and the second terminal fitting 50 are directly electrically connected to the chip fuse 30. The first terminal fitting 40 and the second terminal fitting 50 are formed of a conductive material such as metal. Here, the first terminal fitting 40 and the second terminal fitting 50 have, for example, a plate shape, and are formed by press molding using a metal plate as a base material.

The first terminal fitting 40 includes, for example, a first electrical connection portion 41 electrically connected directly to the first electrode 31 of the chip fuse 30. The first electrode 31 is directly and electrically connected to the first electrical connection portion 41 by laser welding, soldering, or the like in a state where the first electrode 31 is fitted in a recess 90 which will be described later. The first electrical connection portion 41 is formed as, for example, a flat plate-shaped narrow portion having a smaller lateral width in the width direction Y than a conductor connection portion 42, and the first electrode 31 is connected to the narrow portion.

The conductor connection portion 42 is, for example, electrically connected directly or indirectly to the connection conductor 10. The conductor connection portion 42 is provided at an end portion opposite to the first electrical connection portion 41 in the arrangement direction X. The conductor connection portion 42 is formed in a flat plate shape, and is directly electrically connected to the connection conductor 10 by laser welding, ultrasonic bonding, or the like, with their flat surfaces overlapping each other. The conductor connection portion 42 illustrated here is formed in a rectangular flat plate shape. The connection conductor 10 is an example of a first electrical connection target connected to the first terminal fitting 40. The first terminal fitting 40 is formed in, for example, one flat plate shape in which the first electrical connection portion 41 and the conductor connection portion 42 are adjacent to each other in the arrangement direction X.

The second terminal fitting 50 includes, for example, a second electrical connection portion 51 electrically connected directly to the second electrode 32 of the chip fuse 30. The second electrode 32 is directly and electrically connected to the second electrical connection portion 51 by laser welding, soldering, or the like in a state where the second electrode 32 is fitted in the recess 90 which will be described later. The second electrical connection portion 51 is formed in, for example, a convex flat plate shape, and the second electrode 32 is connected to the convex narrow portion.

In addition, the second terminal fitting 50 has a joint portion 52 electrically connected directly to the wiring member 60 of the battery monitoring unit 100. The joint portion 52 is provided at an end portion opposite to the second electrical connection portion 51 in the arrangement direction X. The battery monitoring unit 100 includes the wiring member 60 interposed between the second terminal fitting 50 and the unit body, and indirectly electrically connects the second terminal fitting 50 to the unit body of the battery monitoring unit 100 via the wiring member 60.

The wiring member 60 includes, for example, a conductor portion 61 having one end portion electrically connected directly to the second terminal fitting 50 and the other end portion electrically connected directly or indirectly to the battery monitoring unit 100. In the wiring member 60, the conductor portion 61 is covered with an electrically insulating coating 62. The wiring member 60 described here is a linear conductor having the conductor portion 61 formed in a linear shape. Specifically, the wiring member 60 is an electric wire in which a core wire as the conductor portion 61 is covered with the electrically insulating coating 62, and the joint portion 52 is bonded to one end portion of the conductor portion 61 at the terminal thereof.

For example, the insulating coating 62 is peeled off at one end portion of the wiring member 60, and the joint portion 52 is bonded to the conductor portion 61 exposed from the insulating coating 62. In this case, the joint portion 52 is configured as, for example, a caulking crimp portion to be caulked and fixed to one end portion of the conductor portion 61. Note that the joint portion 52 is not limited to this example, and may be bonded to the conductor portion 61 of the wiring member 60 by, for example, laser welding, ultrasonic bonding, pressure welding, soldering, or the like. In addition, for example, as the wiring member 60, one in which one end portion of the conductor portion 61 is covered with the insulating coating 62 at the terminal may be used. In this case, the joint portion 52 may be configured as a pair of pressure welding blades that makes a cut in the insulating coating 62 at the end of the wiring member 60 and sandwiches one end portion of the conductor portion 61 (core wire of the end of the electric wire).

In the present embodiment, the battery monitoring unit 100 is an example of a second electrical connection target connected to the second terminal fitting 50. The second terminal fitting 50 is disposed in a straight line in the arrangement direction X with respect to the first terminal fitting 40 at a distance therefrom. In the second terminal fitting 50, for example, the second electrical connection portion 51 and the joint portion 52 are adjacent to each other in the arrangement direction X. The joint portion 52 allows the wiring member 60 to be drawn out toward the other end side in the arrangement direction X.

Note that the wiring member 60 may be, for example, a flat wiring material such as a flexible printed circuit board in which the conductor portion 61 is formed as a wiring pattern. In this case, the wiring member 60 has the conductor portion 61 formed for each second terminal fitting 50 in the plurality of fuse units 20, and one end portion of the conductor portion 61 is provided at the terminal of a branch portion branched from the main body for each second terminal fitting 50. One end portion of the conductor portion 61 is electrically connected directly to the joint portion 52 by, for example, laser welding, soldering, or the like.

Here, in the fuse unit 20, the first electrical connection portion 41 of the first terminal fitting 40 and the second electrical connection portion 51 of the second terminal fitting 50 are disposed on the same plane in the arrangement direction X with a predetermined distance therebetween. The predetermined distance is a distance between the first electrode 31 and the second electrode 32 of the chip fuse 30 (in other words, the inter-electrode pitch). Therefore, the first terminal fitting 40 and the second terminal fitting 50 are disposed such that the distance between the first electrical connection portion 41 and the second electrical connection portion 51 matches the inter-electrode pitch between the first electrode 31 and the second electrode 32. The chip fuse 30 is installed across the first electrical connection portion 41 and the second electrical connection portion 51.

The resin member 70 protects the chip fuse 30, for example, by covering the periphery of the chip fuse 30. The resin member 70 is made of, for example, an electrically insulating resin material, and houses the first electrical connection portion 41, the second electrical connection portion 51, and the chip fuse 30. That is, the resin member 70 is provided with a housing chamber 70a in which the first electrical connection portion 41, the second electrical connection portion 51, and the chip fuse 30 are housed.

The resin member 70 includes, for example, a plurality of housing members that are assembled and fixed to each other to form the housing chamber 70a inside. Specifically, the resin member 70 includes, as the plurality of housing members, a first housing member 70A and a second housing member 70B that sandwich the first electrical connection portion 41, the second electrical connection portion 51, and the chip fuse 30 therebetween and house them in the housing chamber 70a. The first housing member 70A and the second housing member 70B are formed of, for example, an electrically insulating material such as synthetic resin. The first housing member 70A and the second housing member 70B are molded as members separate from the first electrical connection portion 41, the second electrical connection portion 51, and the chip fuse 30, and surround the first electrical connection portion 41, the second electrical connection portion 51, and the chip fuse 30 to house them in the housing chamber 70a.

The first housing member 70A includes, for example, an installation surface 71 on which the first electrical connection portion 41 and the second electrical connection portion 51 are placed. The chip fuse 30 is connected to the first electrical connection portion 41 and the second electrical connection portion 51 placed on the installation surface 71. Here, for example, the first housing member 70A is molded as a pedestal member for placing the first electrical connection portion 41 and the second electrical connection portion 51 on the installation surface 71. The first housing member 70A illustrated here is formed in a rectangular flat plate shape.

For example, the second housing member 70B is molded as a cover member that covers the first electrical connection portion 41, the second electrical connection portion 51, and the chip fuse 30 at an assembly completion position with respect to the first housing member 70A as a pedestal member. The second housing member 70B has a lid portion 72 disposed to face the installation surface 71 of the first housing member 70A with the first electrical connection portion 41, the second electrical connection portion 51, and the chip fuse 30 interposed therebetween at the assembly completion position. The lid portion 72 illustrated here is formed in a rectangular flat plate shape, and is disposed parallel to the installation surface 71 of the first housing member 70A at the assembly completion position.

In addition, the second housing member 70B has a pair of first side wall portions 73 that hang down from the lid portion 72 in the height direction Z and are disposed to face each other having a distance therebetween in the arrangement direction X. The first side wall portions 73 illustrated here are formed in a rectangular flat plate shape, and the side portion of the distal end abuts on the installation surface 71 of the first housing member 70A at the assembly completion position. However, a first notch 73a for drawing out the side of the conductor connection portion 42 in the first electrical connection portion 41 to the outside of the housing chamber 70a is formed in the side portion of the distal end of the one first side wall portion 73. Further, a second notch 73b for drawing out the side of the joint portion 52 in the second electrical connection portion 51 to the outside of the housing chamber 70a is formed in the side portion of the distal end of the other first side wall portion 73.

In addition, the second housing member 70B has a pair of second side wall portions 74 that hang down from the lid portion 72 in the height direction Z and are disposed to face each other having a distance therebetween in the width direction Y. The second side wall portions 74 illustrated here are formed in a rectangular flat plate shape, and the side portion of the distal end abuts on the installation surface 71 of the first housing member 70A at the assembly completion position. The second housing member 70B has an internal space surrounded by the lid portion 72, the pair of first side wall portions 73, and the pair of second side wall portions 74. In the resin member 70, when the first housing member 70A and the second housing member 70B are at the assembly completion position, the opening of the internal space of the second housing member 70B is closed by the first housing member 70A to become the housing chamber 70a.

Further, in the resin member 70, for example, the side portion of the distal end of the pair of first side wall portions 73 and the side portion of the distal end of the pair of second side wall portions 74 are fixed to the installation surface 71 of the first housing member 70A by thermal welding or the like at the assembly completion position. In addition, it is desirable that the first housing member 70A and the second housing member 70B are formed and fixed in a shape in which the distance therebetween can be eliminated at the assembly completion position so as to form a space in which the housing chamber 70a is sealed at the assembly completion position, for example. As a result, the fuse unit 20 can suppress entry of liquid, dust, and the like into the housing chamber 70a, and thus, it is possible to suppress deterioration in quality, deterioration in durability, and the like due to the entry of the liquid and the like.

Here, a first positioning structure 75A responsible for positioning the first electrical connection portion 41 with respect to the installation surface 71 is provided between the installation surface 71 of the first housing member 70A and the first electrical connection portion 41. In addition, a second positioning structure 75B responsible for positioning the second electrical connection portion 51 with respect to the installation surface 71 is provided between the installation surface 71 of the first housing member 70A and the second electrical connection portion 51. The first positioning structure 75A and the second positioning structure 75B position the first electrical connection portion 41 and the second electrical connection portion 51 by matching distance between the first electrical connection portion 41 and the second electrical connection portion 51 with the inter-electrode pitch between the first electrode 31 and the second electrode 32.

The first positioning structure 75A includes, for example, a first protrusion 71a and a first opening 41b. The first protrusion 71a is provided on the first housing member 70A of the resin member 70. The first protrusion 71a protrudes in the height direction Z from the installation surface 71 of the first housing member 70A. The first opening 41b is provided in the first electrical connection portion 41 of the first terminal fitting 40 and has a size that can be fitted to the first protrusion 71a. In the first positioning structure 75A illustrated here, the first protrusion 71a is formed in a cylindrical shape, and the first opening 41b is formed as a circular through hole. However, in the first positioning structure 75A, in order to suppress the rotation of the first terminal fitting 40 around the axis of the first protrusion 71a, for example, the first protrusion 71a may be formed in a prismatic shape, and the first opening 41b may be formed as a rectangular through hole.

The second positioning structure 75B includes, for example, a second protrusion 71b and a second opening 51b. The second protrusion 71b is provided on the first housing member 70A of the resin member 70. The second protrusion 71b protrudes in the height direction Z from the installation surface 71 of the first housing member 70A. The second opening 51b is provided in the second electrical connection portion 51 of the second terminal fitting 50 and has a size that can be fitted to the second protrusion 71b. In the second positioning structure 75B illustrated here, the second protrusion 71b is formed in a cylindrical shape, and the second opening 51b is formed as a circular through hole. However, in the second positioning structure 75B, in order to suppress the rotation of the second terminal fitting 50 around the axis of the second protrusion 71b, for example, the second protrusion 71b may be formed in a prismatic shape, and the second opening 51b may be formed as a rectangular through hole.

The first housing member 70A is a plate body extending in the arrangement direction X, and is formed to include a region from a first forming position where the first opening 41b of the first terminal fitting 40 is formed to a second forming position where the second opening 51b of the second terminal fitting 50 is formed. In the first housing member 70A, the first protrusion 71a is provided at one end portion in the arrangement direction X, and the second protrusion 71b is provided at the other end portion in the arrangement direction X. The first housing member 70A holds the first terminal fitting 40 and the second terminal fitting 50 by fitting the first protrusion 71a into the first opening 41b and fitting the second protrusion 71b into the second opening 51b, and maintains the distance between the first terminal fitting 40 and the second terminal fitting 50.

Here, in the present embodiment, the first electrical connection portion 41 and the second electrical connection portion 51 are provided with a pair of recesses 90 (refer to FIGS. 4 and 5) that are recessed from the respective distal end surfaces in directions away from each other in the arrangement direction X and into which the chip fuse 30 is fitted. The pair of recesses 90 penetrates the first electrical connection portion 41 and the second electrical connection portion 51 in the height direction Z and is open toward sides approaching each other in the arrangement direction X. The pair of recesses 90 is provided, for example, at the center of the first electrical connection portion 41 and the second electrical connection portion 51 in the width direction Y, and has a depth in the arrangement direction X substantially equal to the thickness (length) of the first electrode 31 and the second electrode 32 in the arrangement direction X.

In the present embodiment, for example, as compared with a case where the chip fuse 30 is placed on the first electrical connection portion 41 and the second electrical connection portion 51, at least a part of the chip fuse 30 is fitted in the pair of recesses 90, whereby the chip fuse 30 is lowered by one stage by a thickness in the height direction Z of the first electrical connection portion 41 and the second electrical connection portion 51. As a result, the entire fuse unit 20 including the chip fuse 30, the first terminal fitting 40, the second terminal fitting 50, and the resin member 70 can be made more compact in the height direction Z. In addition, by fitting the chip fuse 30 in the pair of recesses 90, relative movement of the chip fuse 30 with respect to the first terminal fitting 40 and the second terminal fitting 50 in the arrangement direction X, relative movement thereof in the width direction Y, and the like can be restricted, and thus workability of assembly work can be improved.

Although the case where the thicknesses of the first terminal fitting 40 and the second terminal fitting 50 in the height direction Z are less than the height of the chip fuse 30 has been exemplified in the present embodiment, the present invention is not limited to this example, and for example, the thicknesses of the first terminal fitting 40 and the second terminal fitting 50 in the height direction Z may be substantially the same as the height of the chip fuse 30. In the present embodiment, since the chip fuse 30 is fitted in the pair of recesses 90, for example, even when the thicknesses of the first terminal fitting 40 and the second terminal fitting 50 in the height direction Z are substantially the same as the height of the chip fuse 30, it is possible to suppress an increase in size of the entire fuse unit 20 in the height direction Z.

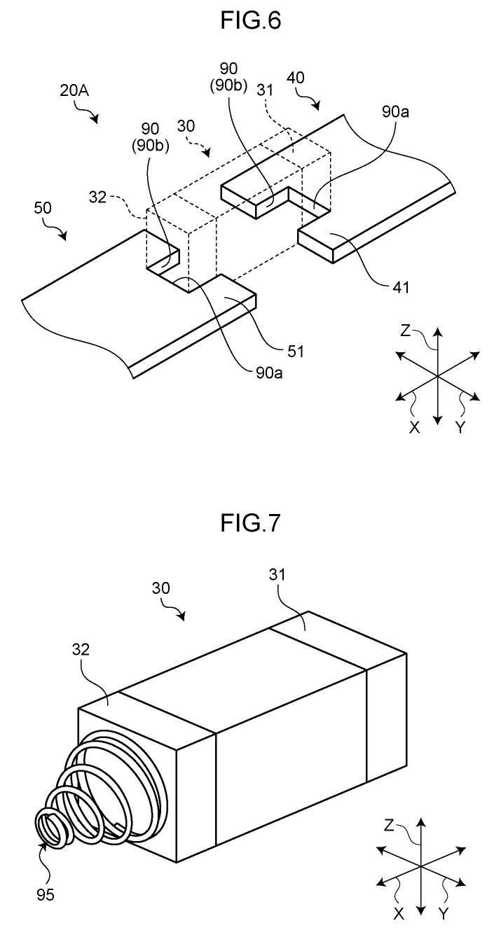

In the fuse unit 20 of the present embodiment having the above configuration, for example, the first electrical connection portion 41, the second electrical connection portion 51, and the chip fuse 30 are installed on the installation surface 71 of the first housing member 70A. In the fuse unit 20, for example, in a state in which the chip fuse 30 is fitted in the pair of recesses 90 and the first electrical connection portion 41, the second electrical connection portion 51, and the chip fuse 30 are integrated, the first opening 41b of the first positioning structure 75A is inserted into the first protrusion 71a, and the second opening 51b of the second positioning structure 75B is inserted into the second protrusion 71b. Note that the fuse unit 20 is not limited to this example, and for example, the chip fuse 30 may be inserted into the pair of recesses 90 with respect to the first electrical connection portion 41 and the second electrical connection portion 51 positioned with respect to the installation surface 71 of the first housing member 70A by the first positioning structure 75A and the second positioning structure 75B. Then, along bottom portions 90a (refer to FIG. 6) and pairs of side surfaces 90b of the pair of recesses 90, the first electrode 31 and the first electrical connection portion 41 are bonded by soldering, laser welding, or the like, and the second electrode 32 and the second electrical connection portion 51 are bonded by soldering, laser welding, or the like.

At this time, in the fuse unit 20 of the present embodiment, the first housing member 70A is a pedestal member, and there is no wall portion or the like that covers the periphery of the first electrical connection portion 41, the second electrical connection portion 51, and the chip fuse 30 installed on the installation surface 71. Therefore, in the fuse unit 20, a laser irradiator, a soldering iron, and the like can be brought close to the first electrode 31 and the first electrical connection portion 41, and to the second electrode 32 and the second electrical connection portion 51 from various directions. As a result, laser light can be radiated from any direction to the region between the first electrode 31 and the first electrical connection portion 41 and the region between the second electrode 32 and the second electrical connection portion 51, and soldering can be performed on the regions with a soldering iron from any direction. Therefore, the fuse unit 20 can increase the degree of freedom in manufacturing at the time of directly electrically connecting the first electrical connection portion 41, the second electrical connection portion 51, and the chip fuse 30.

Subsequently, in the fuse unit 20 of the present embodiment, the second housing member 70B is put on the first electrical connection portion 41, the second electrical connection portion 51, and the chip fuse 30, and the first housing member 70A and the second housing member 70B at the assembly completion position are fixed by thermal welding or the like. As a result, the chip fuse 30, the first terminal fitting 40, the second terminal fitting 50, the resin member 70, and the like can be assembled to manufacture the fuse unit 20.

In FIG. 1, the conductive module 1 includes an electrically insulating module resin part 80 in which the fuse unit 20 is housed together with the connection conductor 10. The module resin part 80 is provided with a conductor housing chamber 80a that houses the connection conductor 10 and a unit housing chamber 80b that houses the fuse unit 20. For example, the module resin part 80 has the conductor housing chamber 80a for each of the connection conductors 10 connected to the respective electrode terminals BCb of the electrode terminal group BCc. On the other hand, the module resin part 80 has the unit housing chamber 80b in which the fuse units 20 for each of the connection conductors 10 are collectively accommodated.

In the unit housing chamber 80b, the wiring member 60 of each fuse unit 20 is routed to the unit body side of the battery monitoring unit 100. In each wiring member 60, the other end of the tip routed to the unit body side of the battery monitoring unit 100 is connected to a connector 65. Then, each wiring member 60 is indirectly electrically connected to the unit body of the battery monitoring unit 100 via the connector 65.

The module resin part 80 includes a first module housing member 80A and a second module housing member (not illustrated) that are assembled and fixed to each other and form the plurality of conductor housing chambers 80a and the unit housing chamber 80b inward. The first module housing member 80A and the second module housing member are formed of an electrically insulating material such as a synthetic resin. The first module housing member 80A is provided with a space portion for forming the plurality of conductor housing chambers 80a and the unit housing chamber 80b. The second module housing member is molded as a cover member that covers the opening of each space portion.

As described above, in the fuse unit 20 and the conductive module 1 of the present embodiment, the first electrical connection portion 41 and the second electrical connection portion 51 are provided with the pair of recesses 90 that are recessed from the respective distal end surfaces in the direction away from each other in the arrangement direction X and into which the chip fuse 30 is fitted. With this configuration, in the fuse unit 20 and the conductive module 1, for example, the chip fuse 30 is fitted in the pair of recesses 90, and thus the relative movement of the chip fuse 30 in the arrangement direction X with respect to the first terminal fitting 40 and the second terminal fitting 50, the relative movement thereof in the width direction Y, and the like can be restricted. As a result, the fuse unit 20 and the conductive module 1 can improve workability of assembly work. Further, for example, as compared with a case where the chip fuse 30 is placed on the first electrical connection portion 41 and the second electrical connection portion 51, the entire fuse unit 20 can be made more compact in the height direction Z.

In addition, the fuse unit 20 of the present embodiment includes the insulating resin member 70 that covers the chip fuse 30 installed across the first electrical connection portion 41 and the second electrical connection portion 51. With this configuration, in the fuse unit 20, for example, the chip fuse 30 can be protected by the resin member 70, and degradation of the performance of the chip fuse 30 can be suppressed.

### First Modified Example

FIG. 6 is a perspective view of the vicinity of a pair of recesses 90 of a fuse unit 20A according to a first modified example, and FIG. 7 is a perspective view of a chip fuse 30 of the fuse unit 20A. The fuse unit 20A illustrated in FIGS. 6 and 7 has the same configuration as the fuse unit 20 of the above embodiment. Therefore, the fuse unit 20A can obtain the same operation and effect as those of the above embodiment based on the same configuration.

However, as illustrated in FIGS. 6 and 7, the present modified example is different from the above embodiment in that an elastic member 95 is provided in the chip fuse 30. The elastic member 95 is configured by, for example, a conductive coil spring, and is configured to be expandable and contractible (deformable) in the arrangement direction X. Note that the elastic member 95 is not illustrated in FIG. 6 for convenience. In the present modified example, the elastic member 95 is provided on the end surface of the second electrode 32 of the chip fuse 30 in the arrangement direction X, and protrudes from the end surface in the arrangement direction X. The elastic member 95 is bonded to the end surface of the second electrode 32 by laser welding, soldering, or the like, for example, and constitutes a part of the second electrode 32. At least a part of the distal end portion of the elastic member 95 is locked to the bottom portion 90a of the recess 90. The second electrical connection portion 51 (the bottom portion 90a of the recess 90) may be provided with a protruding portion that protrudes in the height direction Z and faces the distal end portion of the elastic member 95 in the arrangement direction X. In the present modified example, since the elastic member 95 is provided in the chip fuse 30, for example, even after the first terminal fitting 40 and the second terminal fitting 50 have been assembled to an assembly member such as the resin member 70, with respect to the first terminal fitting 40 and the second terminal fitting 50 in such an assembled state, the chip fuse 30 can be fitted into the pair of recesses 90 more easily, more smoothly, or more accurately.

Further, the present modified example is also different from the above embodiment in that the resin member 70 (refer to FIG. 3) covering the chip fuse 30 is not provided. The chip fuse 30 is covered and protected by the second module housing member (cover) of the module resin part 80 described above, for example, in a state where the fuse unit 20 is mounted on the conductive module 1 (refer to FIG. 1). Although a case where the elastic member 95 is provided on the second electrode 32 of the chip fuse 30 has been exemplified in the present modified example, the present modified example is not limited to this example, and for example, a pair of elastic members 95 may be provided on each of the first electrode 31 and the second electrode 32 of the chip fuse 30. Furthermore, a case where the elastic member 95 is configured by a conductive coil spring has been exemplified in the present modified example, the present modified example is not limited to this example, and the elastic member 95 may be configured by, for example, conductive rubber or the like.

As described above, in the fuse unit 20A of the present modified example, at least one of the pair of recesses 90 is provided with the elastic member 95 having conductivity, which is interposed between the one bottom portion 90a and the chip fuse 30 and is expandable and contractible in the arrangement direction X. With this configuration, the fuse unit 20A can absorb the tolerance in the arrangement direction X between the first terminal fitting 40 and the second terminal fitting 50 (between the pair of recesses 90) while ensuring the proper electrical connection state of the chip fuse 30 with respect to the first electrical connection portion 41 and the second electrical connection portion 51 by the elastic member 95, for example.

### Second Modified Example

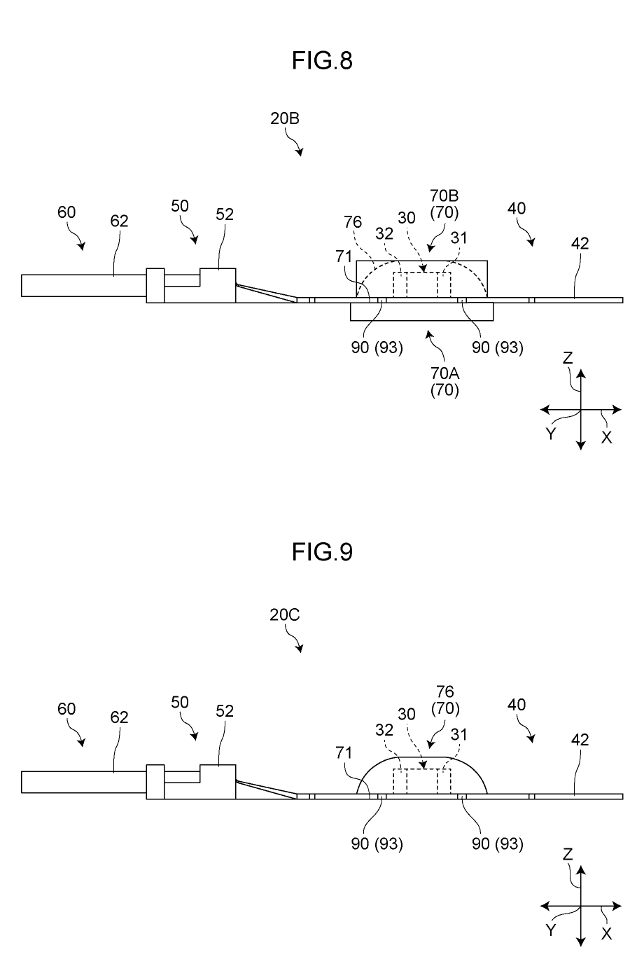

FIG. 8 is a perspective view of a fuse unit 20B according to a second modified example. A fuse unit 20B illustrated in FIG. 8 has the same configuration as the fuse unit 20 of the above embodiment. Therefore, the fuse unit 20B can obtain the same operation and effect as those of the above embodiment based on the same configuration.

However, as illustrated in FIG. 8, the present modified example is different from the above-described embodiment in that an electrically insulating coating resin portion 76 enclosing the chip fuse 30, the first electrical connection portion 41, and the second electrical connection portion 51 is provided inside the resin member 70. The coating resin portion 76 encloses, for example, the chip fuse 30, the first electrical connection portion 41, and the second electrical connection portion 51, thereby suppressing current flow between the first electrical connection portion 41 and the second electrical connection portion 51. For example, even if dew condensation occurs in the housing chamber 70a of the resin member 70, the coating resin portion 76 can suppress a short circuit in the housing chamber 70a due to the dew condensation water. In addition, the coating resin portion 76 functions as, for example, a fixing member that fixes the first electrical connection portion 41, the second electrical connection portion 51, and the chip fuse 30 to the first housing member 70A and the second housing member 70B in the housing chamber 70a.

The coating resin portion 76 is, for example, a solidified material that is filled in the housing chamber 70a and encloses the chip fuse 30, the first electrical connection portion 41, and the second electrical connection portion 51. In this case, for example, a supply hole (not illustrated) for supplying a liquid resin material to the inside of the first housing member 70A and the second housing member 70B (housing chamber 70a) at the assembly completion position is provided in any one of the first housing member 70A and the second housing member 70B. Here, if there is no gap between the first housing member 70A and the second housing member 70B at the assembly completion position, that is, if the airtightness of the housing chamber 70a is high, either one of the first housing member 70A and the second housing member 70B is provided with an air vent hole (not illustrated) for releasing the gas in the housing chamber 70a to the outside of the room during supply of the liquid resin material.

Then, the liquid resin material is supplied from the supply hole to the inner side (housing chamber 70a) of the first housing member 70A and the second housing member 70B at the assembly completion position and filled, and the resin material is cured to form the coating resin portion 76. At this time, a part of the resin material is supplied to a pair of slits 93, and the pair of slits 93 is filled with the resin material. When there is a gap between the first housing member 70A and the second housing member 70B at the assembly completion position (when the airtightness of the housing chamber 70a is low), or when there is a concern that the liquid resin material may flow out from the housing chamber 70a, for example, when there is a need to provide a supply hole or an air vent hole on the other end side (lower side) in the height direction Z, it is desirable to form the coating resin portion 76 using a liquid resin material having a viscosity that allows it to be retained in the housing chamber 70a until it is cured.

FIG. 9 is a side view of a fuse unit 20C according to a third modified example. The fuse unit 20C illustrated in FIG. 9 has the same configuration as the fuse unit 20 of the above embodiment. Therefore, the fuse unit 20C can obtain the same operation and effect as those of the above embodiment based on the same configuration.

However, the present modified example is different from the above-described embodiment in that the resin member 70 is formed only of the coating resin portion 76 as illustrated in FIG. 9. That is, in the present modified example, the resin member 70 is not provided with the first housing member 70A and the second housing member 70B in a case shape, and the periphery of the chip fuse 30, the first electrical connection portion 41, and the second electrical connection portion 51 is covered with the coating resin portion 76.

The coating resin portion 76 is, for example, a solidified material of a liquid resin material (so-called potting material) supplied by dropping or the like so as to enclose the chip fuse 30, the first electrical connection portion 41, and the second electrical connection portion 51. In this case, first, the liquid potting material is supplied to the chip fuse 30, the first electrical connection portion 41, and the second electrical connection portion 51. Thereafter, the coating resin portion 76 in which the potting material is cured is formed by irradiating the potting material with ultraviolet rays or heating the potting material according to the properties of the potting material. Since the coating resin portion 76 undergoes such a manufacturing process, it is desirable to form the coating resin portion using a liquid potting material having viscosity that allows it to be retained on the first terminal fitting 40 and the second terminal fitting 50 until curing such that the liquid potting material does not flow out from the first terminal fitting 40 and the second terminal fitting 50 before curing.

Here, in the case of an ultraviolet curing type potting material, it is necessary to bring an ultraviolet irradiator close to the liquid potting material. In the present modified example, the first terminal fitting 40 and the second terminal fitting 50 are base members, and there is no wall portion or the like that covers the periphery of the supplied liquid potting material. Therefore, in the fuse unit 20C, the ultraviolet irradiator can be brought close to the liquid potting material from various directions on the first terminal fitting 40 and the second terminal fitting 50, and the ultraviolet ray can be irradiated from any direction toward the liquid potting material. Therefore, the fuse unit 20C can increase the degree of freedom in manufacturing at the time of forming the coating resin portion 76.

Cases where the first positioning structure 75A and the second positioning structure 75B are provided in the resin member 70, the first electrical connection portion 41, and the second electrical connection portion 51 have been exemplified in the above embodiment and the above modified examples, but the present invention is not limited to this example, and for example, the first positioning structure 75A and the second positioning structure 75B may not be provided. Further, for example, the coating resin portion 76 covering the chip fuse 30 may be formed by resin molding. Specifically, the coating resin portion 76 may be formed by assembling the first terminal fitting 40 and the second terminal fitting 50 to the first housing member 70A, connecting the chip fuse 30 between the first terminal fitting 40 and the second terminal fitting 50, and then insert molding the resultant as an insert. In addition, the part of the coating resin portion 76 and the first housing member 70A may be formed by insert molding the structure obtained by connecting the chip fuse 30 between the first terminal fitting 40 and the second terminal fitting 50 as an insert.

Although the embodiment and the modified examples of the present invention have been exemplified above, the embodiment and the modified examples are merely examples, and are not intended to limit the scope of the invention. The above-described embodiments and modified examples can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

The fuse unit and the conductive module according to the present embodiment have an effect of improving workability of assembling work.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a chip fuse that melts a fusible portion when an overcurrent flows between a first electrical connection target and a second electrical connection target;
a first terminal fitting including a first electrical connection portion electrically connected to a first electrode of the chip fuse, and electrically connected to the first electrical connection target; and
a second terminal fitting including a second electrical connection portion electrically connected to a second electrode of the chip fuse, and electrically connected to the second electrical connection target, wherein
the first electrical connection portion and the second electrical connection portion are provided with a pair of recesses recessed from respective distal end surfaces in directions away from each other in an arrangement direction of the first terminal fitting and the second terminal fitting, into which the chip fuse is fitted.

2. The fuse unit according to claim 1, wherein
at least one of the pair of recesses is provided with a conductive elastic member interposed between a bottom portion of the one recess and the chip fuse and expandable and contractible in the arrangement direction.

3. The fuse unit according to claim 1, further comprising:
an insulating resin member covering the chip fuse installed across the first electrical connection portion and the second electrical connection portion.

4. The fuse unit according to claim 2, further comprising:
an insulating resin member covering the chip fuse installed across the first electrical connection portion and the second electrical connection portion.

5. A conductive module comprising:
a connection conductor electrically connected to an electrode terminal of a battery cell constituting a battery module; and
a fuse unit that electrically connects the connection conductor to a battery monitoring unit that monitors a battery state of the battery cell, wherein
the fuse unit includes:
a chip fuse that melts a fusible portion when an overcurrent flows between the connection conductor and the battery monitoring unit;
a first terminal fitting including a first electrical connection portion electrically connected to a first electrode of the chip fuse, and electrically connected to the connection conductor; and
a second terminal fitting including a second electrical connection portion electrically connected to a second electrode of the chip fuse, and electrically connected to the battery monitoring unit, and
the first electrical connection portion and the second electrical connection portion are provided with a pair of recesses recessed from respective distal end surfaces in directions away from each other in an arrangement direction of the first terminal fitting and the second terminal fitting, into which the chip fuse is fitted.
